(19) United States
(12) Patent Application Publication
(10) Pub. No.: US 2008/0049864 A1
(43) Pub. Date: Feb. 28, 2008

(54) METHOD AND APPARATUS FOR SPECTRUM-PRESERVING AMPLITUDE COMPRESSION OF A MODULATED SIGNAL

(76) Inventors: Stefan G. Eriksson, Bromma (SE); Marten Sundberg, Stockholm (SE)

Correspondence Address: ERICSSON INC., 6300 LEGACY DRIVE, M/S EVR 1-C-11, PLANO, TX, 75024, US

(21) Appl. No.: 11/843,467

(22) Filed: Aug. 22, 2007

Related U.S. Application Data
(60) Provisional application No. 60/823,705, filed on Aug. 28, 2006.

(51) Int. Cl. H04L 27/04; H04L 5/12

(52) U.S. Cl. 375/269; 375/261; 375/268

(57) ABSTRACT

A method and associated apparatus for preserving frequency spectrum in a linear modulation scheme, by adding a compensation signal to a modulated signal, the compensation signal having the same spectrum as the modulated signal. In the present invention, peaks above a pre-determined maximum threshold and/or minima below a pre-determined minimum threshold are searched. When a peak is found, the amount by which the signal peak exceeds the maximum threshold, as well as the signal phase at the peak is calculated. A compensation signal is generated with the same peak amplitude as the signal exceeds the maximum threshold, and with opposite phase. Then the shape of the compensation signal is chosen to be the same as the transmitter pulse of the modulated signal. Finally, the compensation signal is added to the modulated signal.

### CROSS-REFERENCE TO RELATED APPLICATIONS

This application claims the benefit of U.S. Provisional Application No. 60/823,705, filed Aug. 28, 2006, the disclosure of which is incorporated herein by reference.

### BACKGROUND

Digital information can be transmitted over an analog medium (such as a radio channel) by means of a digital modulation, as seen in FIG. 1. The digital information is mapped onto a predefined set of (complex) digital signals using a digital modulator 101. These are converted to analog signals using a digital-to-analog converter (DAC) 102, converted to a suitable carrier frequency using an up-converter 103, amplified to get a sufficient transmit power using a power amplifier (PA) 104 and converted to a radio signal by the antenna 105.

In case of a linear modulation, the digital modulator can map from binary digits to a modulation constellation (a predefined set of complex values), followed by up-sampling and a pulse shaping filter.

A digital modulator may encode the digital information to signals with e.g. different amplitude or phase, or a combination of these. The modulation type Gaussian minimum shift keying (GMSK) which is used e.g. for GSM, encodes the information solely in the phase of the signal, whereas the amplitude is constant. Another modulation type, octonary phase shift keying (8 PSK), which is used e.g. for EDGE, encodes the digital information both in the phase and the amplitude of the modulated signal. The constellation mapping itself uses the phase to encode the digital information. The subsequent (low-pass) pulse shaping filter smears out the signal in the time domain, causing an amplitude variation of the modulated signal. The amplitude information is important for correct reception of the signal at the receiver end. The modulation types 16-ary, 32-ary and 64-ary quadrature amplitude modulation (16 QAM, 32 QAM and 64 QAM), used in systems other than GSM/EDGE, also use a combination of phase and amplitude to encode the digital signal.

A power amplifier (PA) amplifies the analog signal to transmit sufficient output power from the antenna. The PA will perform undistorted amplification only within a certain range of amplitude of the input signal, called the linear region. If the input signal amplitude is too small or too large, the output signal will be distorted, i.e., the phase and/or amplitude variations of the output signal will be different from those of the input signal. If the distortion is too large, it will degrade performance at the receiver end. It will also change the frequency spectrum of the transmitted signal, causing harmonics outside the transmitter's frequency band that will interfere with other radio links. To avoid distortion, the amplitude variations of the signal should not be larger than the linear region of the PA.

A GMSK modulated signal, having constant amplitude, is not sensitive to the non-linearity of the PA since no information is embedded in the amplitude of the signal. Consequently, the PA can be operated at full power.

With other modulations such as 8 PSK and QAM, on the other hand, the amplitude and power peaks of the modulated signal can be significantly higher than the average signal amplitude and power. To ensure that these power peaks do not exceed the upper limit of the linear region, the average power must be reduced. This is called power back-off and the result is reduced output power and therefore reduced coverage. Further, the amplitude/power minima may be lower than the average amplitude/power (or even zero, so called zero crossings). This problem can be reduced to some extent by using constellation rotation and different pulse shaping filters.

The variations in power of a signal can be expressed by the peak-to-average ratio (PAR), which is the ratio between the peak power and the average power of the signal, and the minimum-to-average ratio (MAR), which is the ratio between the minimum power and the average power. These measures are usually expressed in dB.

A multi-carrier transmitter utilizes multiple carrier frequencies to transmit data. If the carriers are amplified using a common wideband PA, the amplitude variations of the combined signal is of interest.

At occasions where the signals have the same phase, they will add constructively and peak levels will increase. To illustrate, when two signals with equal average power and equal PAR are added, the PAR of the sum signal is 3 dB higher than the PAR of the individual signals. At other occasions where the signals have opposite phase, the signals add destructively, giving rise to minima. The combined signal may have zero crossings even if the MAR of the each individual signal is 0 dB.

Therefore, PA linearity problems, and hence, the required back-off, are usually larger in multi-carrier transmitters.

Existing PAR reduction techniques include the following: (1) Hard clipping in which an upper amplitude limit is forced onto the signal. This method modifies the frequency spectrum of the signal, giving rise to distortion; (2) Constellation rotation by which rotating the modulation constellation by a certain angle for each new symbol, the PAR of the signal can be changed. For some angles, the PAR will be somewhat lower than the PAR of an un-rotated constellation; (3) Using alternative constellations wherein some constellations give a modulated signal that has a lower PAR than others. By choosing such a constellation, PAR can be somewhat reduced, often at the cost of degraded receiver performance; (4) Using alternative pulse shaping filters as some pulse shaping filters give a modulated signal that has a lower PAR than others. By choosing such a pulse shaping filter, PAR can be somewhat reduced; (5) Tone reservation as, for a multi-carrier system (such as OFDM), some carriers (“tones”) are not used for data transmission. Instead, they are used to transmit a signal that counter-acts the peaks of the multi-carrier signal. This method requires extra carriers that cannot be used for data transmission and is only applicable to multi-carrier systems; and (6) Moving constellation points

Many of the above mentioned PAR reduction techniques could potentially be used also for MAR reduction.

There are a number of problems associated with the foregoing solutions, including: they do not give sufficient reduction of PAR and/or MAR; and/or they change the frequency spectrum of the signal or require extra carriers; and/or they have a large impact on performance (for relevant levels of PAR and MAR); and/or they cannot be applied on single-carrier signals; and/or they have high complexity.

What is desired is a method and apparatus adapted to reduce the amplitude variations of a modulated signal without changing its spectrum.

### SUMMARY

The present invention is a method and apparatus adapted to reduce the amplitude variations of a modulated signal without changing its spectrum. A compensation signal is added to the modulated signal, the compensation signal having the same spectrum as the modulated signal. The method and apparatus can be used to reduce peaks of the modulated signal as well as to increase minima, i.e., avoid zero crossings.

### BRIEF DESCRIPTION OF THE SEVERAL VIEWS OF THE DRAWINGS

In the following section, the invention will be described with reference to exemplary embodiments illustrated in the figures, in which:

FIG. 1 is a block diagram of an apparatus for transmitting digital data over a wireless channel;

FIG. 2 is a graph illustrating an example of peak compression;

FIG. 3 is a graph illustrating an example of minimum compression;

FIG. 4 is a graph of a portion of a signal where both peak and minimum compression have been applied;

FIG. 5 is a graph illustrating the signal power distribution of 8 PSK, 16 QAM and 16 QAM with minimum/maximum compression;

FIG. 6 is a graph illustrating the spectrum of 8 PSK, 16 QAM and 16 QAM with minimum/maximum compression;

FIG. 7 is a graph illustrating the BLER performance impact of smooth minimum compression;

FIG. 8 is a graph that illustrates the BLER performance impact of smooth maximum compression;

FIG. 9 is a graph illustrating how the BLER performance impact of simultaneous minimum and maximum compression;

FIG. 10 is a flow chart of an embodiment of the method of the present invention; and

FIGS. 11A-11C are block diagrams of each of the three embodiments of an apparatus of the present invention.

### DETAILED DESCRIPTION

As used herein, the following abbreviations or terms shall have the following meanings:

16 QAM 16-ary QAM

32 QAM 32-ary QAM

64 QAM 64-ary QAM

8 PSK 8-ary PSK

BLER Block Error Ratio

DAC Digital-to-Analog Converter

dB decibel

dBc decibel over carrier

EDGE Enhanced Data rates for GSM Evolution

GMSK Gaussian Minimum Shift Keying

GSM Global System for Mobile telephony

MAR Minimum-to-Average Ratio

MCS Modulation and Coding Scheme

PA Power Amplifier

PAR Peak-to-Average Ratio

PSK Phase Shift Keying

QAM Quadrature Amplitude Modulation

The present invention is a method an apparatus adapted to reduce the amplitude variations of a modulated signal without changing its spectrum. The method comprises adding a compensation signal to the modulated signal, the compensation signal having the same spectrum as the modulated signal. The apparatus comprises a means for adding a compensation signal to the modulated signal, the compensation signal having the same spectrum as the modulated signal.

The present invention further is adapted to reduce the peaks of the modulated signal as well as to increase minima, i.e., so as to avoid zero crossings. There are different methods for generating the appropriate compensation signal.

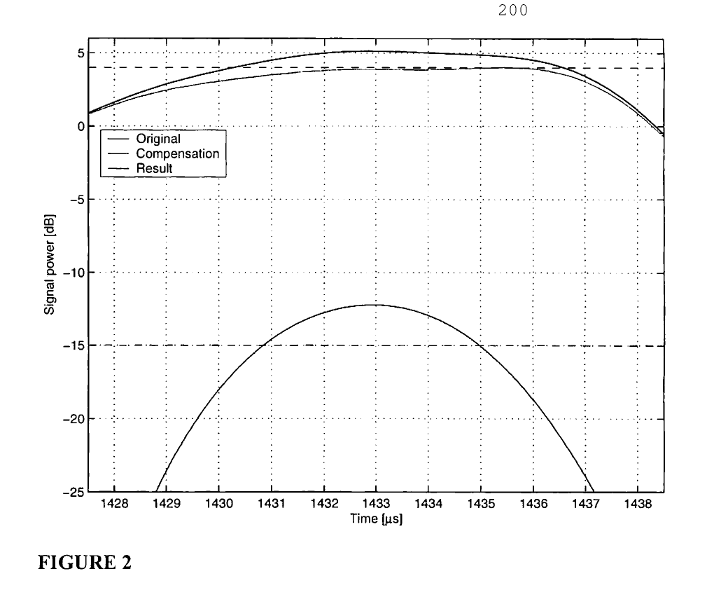

A first method and associated apparatus iteratively searches for peaks above a pre-determined maximum threshold and/or minima below a pre-determined minimum threshold. When a peak is found, the amount by which the signal peak exceeds the maximum threshold, as well as the signal phase at the peak, is calculated. A compensation signal is generated with the same peak amplitude as the signal exceeds the maximum threshold, and with opposite phase. The shape of the compensation signal is chosen to be the same as the transmitter pulse (the impulse response of the pulse shaping filter) of the modulated signal. The compensation signal is then added to the modulated signal. FIG. 2 is a graph 200 illustrating an example of peak compression.

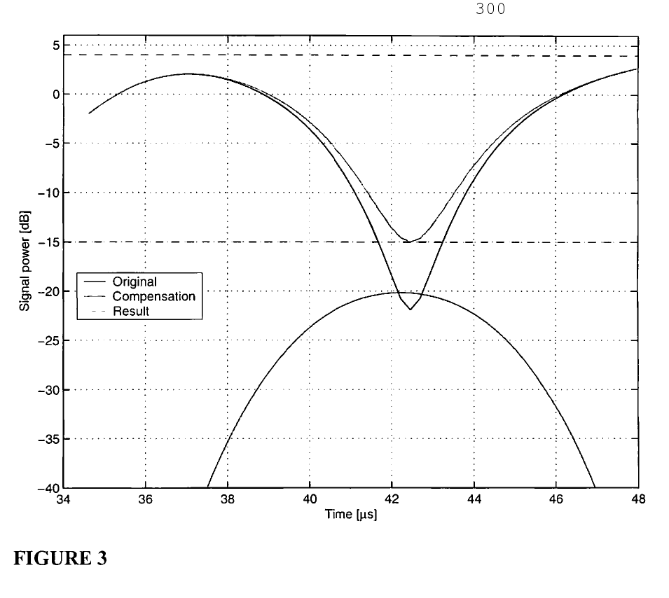

Similarly, when a minimum is found, the amount by which the signal minimum is below the minimum threshold, as well as the signal phase at the minimum, is calculated. A compensation signal is generated with the same peak amplitude as the signal is below the minimum threshold, and with the same phase. The shape of the compensation signal is chosen to be the same as the transmitter pulse of the modulated signal. The compensation signal is then added to the modulated signal. FIG. 3 is a graph 300 illustrating an example of minimum compression.

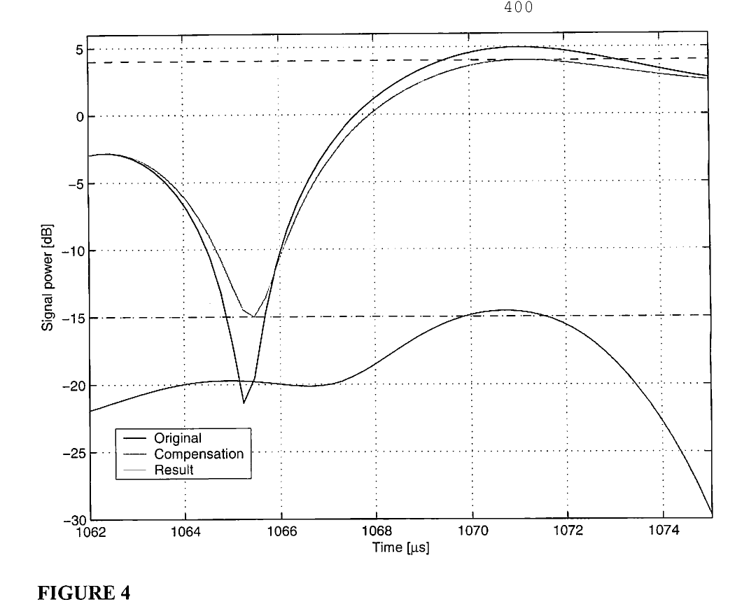

This procedure is iterated until there are no peaks above the maximum threshold and/or no minima below the minimum threshold (possibly limited by a maximum number of iterations for complexity reasons). FIG. 4 is a graph 400 of a portion of a signal where both peak and minimum compression have been applied.

A second method and associated apparatus calculates the compensation signal by first calculating the (complex) difference between the modulated signal and the signal that would be the result if the amplitude of the modulated signal was hard limited to be below the maximum threshold and/or above the minimum threshold (without changing the phase). Second, the compensation signal is fed through a filter whose impulse response is the same as the transmitter pulse. Finally, the filtered compensation signal is added to the modulated signal.

A third method and associated apparatus uses a least squares method to obtain the compensating signal. The least squares method will cancel out the peaks and minima of the signal that lie outside the linear region of the PA in a least squares sense.

In the third method and associated apparatus, the signal amplitudes above and below the pre-defined maximum and minimum limits are detected. Given these values, the signal with equal amplitude as the exceeding parts but with opposite phase is defined. Using this signal and the pre-defined pulse shaping filter, the least squares method is applied to obtain the compensating signal. Since the same pulse shape is used for all symbols, the least squares approach gives a low complexity solution where a pre-calculated matrix can be used. A short example of output of the method and apparatus is described below. Mathematical notations used herein are set forth below:

TABLE 1

| Notation | Explanation |
|---|---|
| ā | Vector a |
| A | Matrix A |
| A^{T} | Matrix transpose of A |
| A⁻¹ | Matrix inverse of A |
| A^{LS}/ā^{LS} | Least-Squares solution of matrix A/vector a |

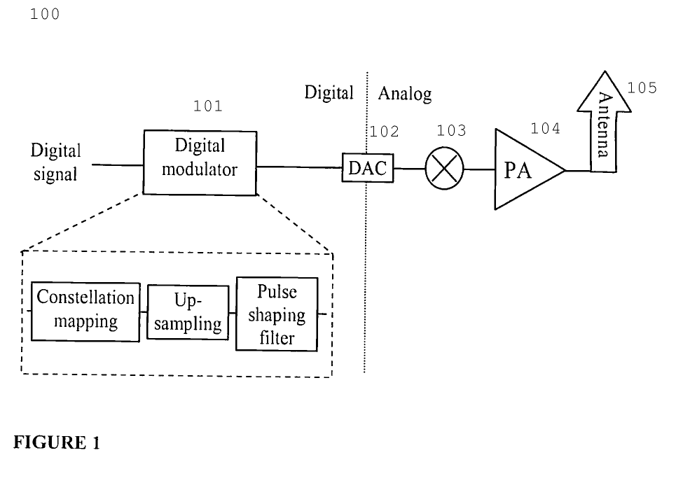

From the constellation mapping of digital bits, as described hereinabove, a symbol vector, s̅, is constructed. The symbol vector is filtered with a pulse shaping filter, P, before the signal is sent to the digital-to-analog converter 102 as seen in FIG. 1. The filtered signal, s̅ₜₓ, could have a wider signal dynamic, i.e. too large and/or too small signal amplitudes, than what is required for the power amplifier (PA) to have optimum performance. Thus, a compensating signal, c̅ₜₓ, needs to be defined that cancels out the signal amplitudes outside of the linear region of the PA.

s̅ₜₓ=P s̅ (signal to be transmitted)

c̅ₜₓ (compensating signal defined from s̅ₜₓ and the amplitude constraints of the PA).

By using the compensating signal and the known pulse shaping filter, a least squares solution can be defined:

c̅ₜₓ^{LS}=P^{LS}ĉₜₓ; where P^{LS}=P(P^{T}P)⁻¹P^{T}.

It is seen that the least squares method only consists of a matrix/vector multiplication, where the matrix, P^{LS}, can be pre-calculated.

There are several advantages of the method and apparatus of the present invention. Advantages include reducing PAR and MAR to arbitrarily chosen levels. Further, it does not change the frequency spectrum of the signal or require extra carriers. It has a small impact on performance (for relevant levels of PAR and MAR), and it can be applied on single-carrier signals as well as multi-carrier signals.

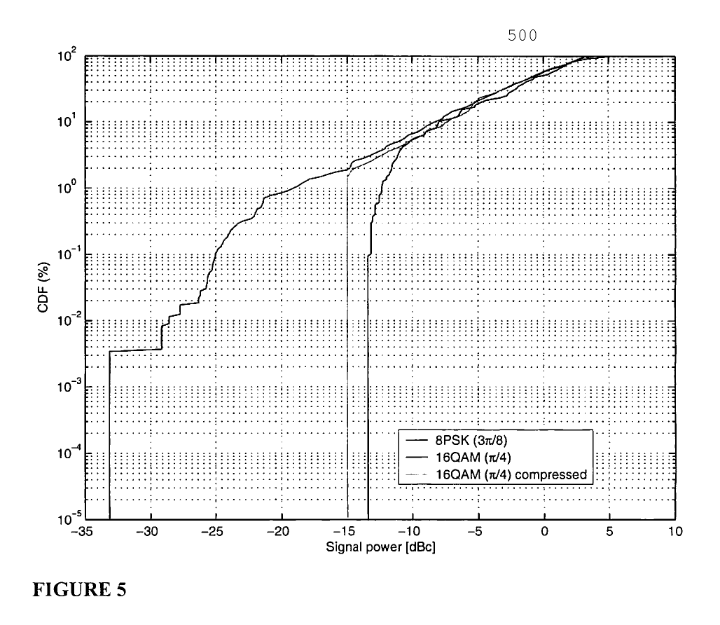

The signal power distribution of 8 PSK, 16 QAM and 16 QAM with minimum/maximum compression is shown in the graph 500 of FIG. 5. In this example, the minimum and maximum compression limits are set to −15 and 4 dBc, respectively.

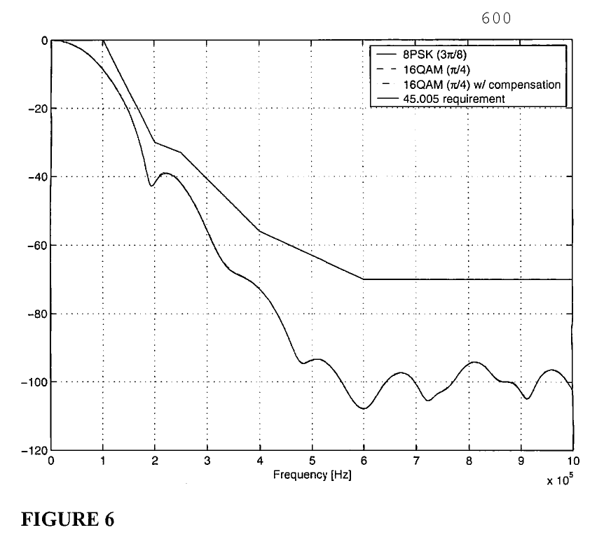

FIG. 6 shows a graph 600 illustrating the spectrum of 8 PSK, 16 QAM and 16 QAM with minimum/maximum compression. It can be seen that the spectrum is not affected by the smooth compression.

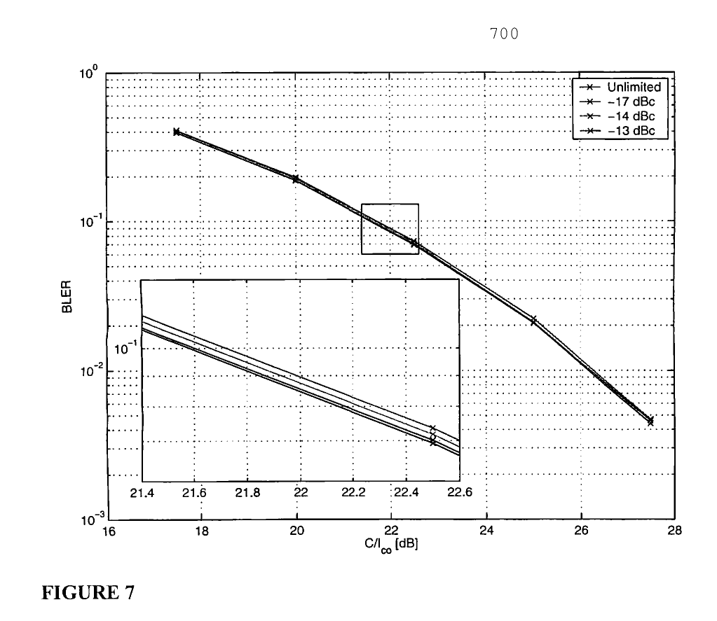

FIG. 7 is a graph 700 illustrating the BLER performance impact of smooth minimum compression. In FIG. 7, it can be seen that the minimum compression has a very limited impact on the performance, even when the lower limit is −14 to −13 dBc. (The lowest level of EDGE (8 PSK modulation with 3π/8 rotation is −13.4 dBc.).

TABLE 2

| | | | | |
|---|---|---|---|---|
| Lower limit | Unlimited | −17 dBc | −14 dBc | −13 dBc |
| Loss @ 10% BLER | — | 0.02 dB | 0.08 dB | 0.14 dB |

Maximum compression

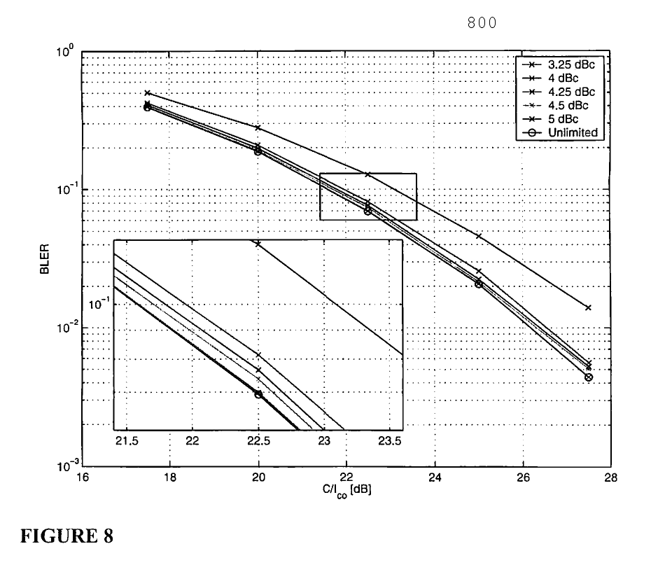

FIG. 8 is a graph illustrating the BLER performance impact of smooth maximum compression. The losses are summarized in Table 3 below.

Limiting the peaks to 4-4.5 dBc has only a minor performance impact. When the upper limit is set to 3.25 dBc (i.e., the same peak level as EDGE), there is a 1.5 dB loss. Note though that this reduces the PAR by 2 dB (from 5.3 dB to 3.25 dB) and therefore allows the output power to be increased by 2 dB. Thus, there is a net gain of 0.5 dB in coverage limited situations.

TABLE 3

| | Upper limit | | | | | |
|---|---|---|---|---|---|---|
| | Unlimited | 5 dBc | 4.5 dBc | 4.25 Bc | 4 dBc | 3.25 dBc |
| Loss @ | — | 0.01 dB | 0.1 dB | 10.2 dB | 0.35 dB | 1.5 dB |
| 10% | | | | | | |
| BLER | | | | | | |
| Net | — | 0.3 dB | 0.7 dB | 0.8 dB | 0.95 dB | 0.5 dB |
| coverage | | | | | | |
| gain | | | | | | |

Minimum and maximum compression

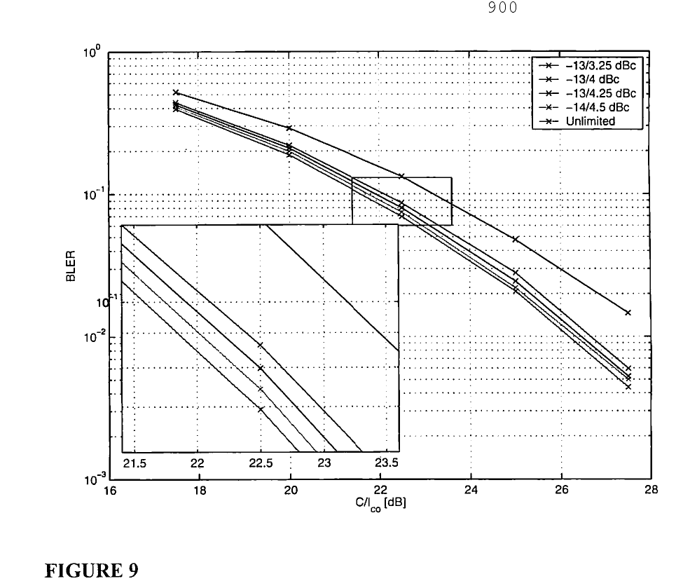

FIG. 9 is a graph 900 illustrating the BLER performance impact of simultaneous minimum and maximum compression. The losses are summarized in Table 4 below.

Comparing Table 2 with Table 3, it can be seen that the losses from minimum and maximum compression are roughly additive.

TABLE 4

| | Lower limit | | | | |
|---|---|---|---|---|---|
| | Unlimited | −14 dBc | −13 dBc | −13 dBc | −13 dBc |
| | Upper limit | | | | |
| | Unlimited | 4.5 dBc | 4.25 Bc | 4 dBc | 3.25 dBc |
| Loss @ | — | 0.15 dB | 0.32 dB | 0.5 dB | 1.6 dB |
| 10% BLER | | | | | |
| Net coverage | — | 0.65 dB | 0.7 dB | 0.8 dB | 0.4 dB |
| gain | | | | | |

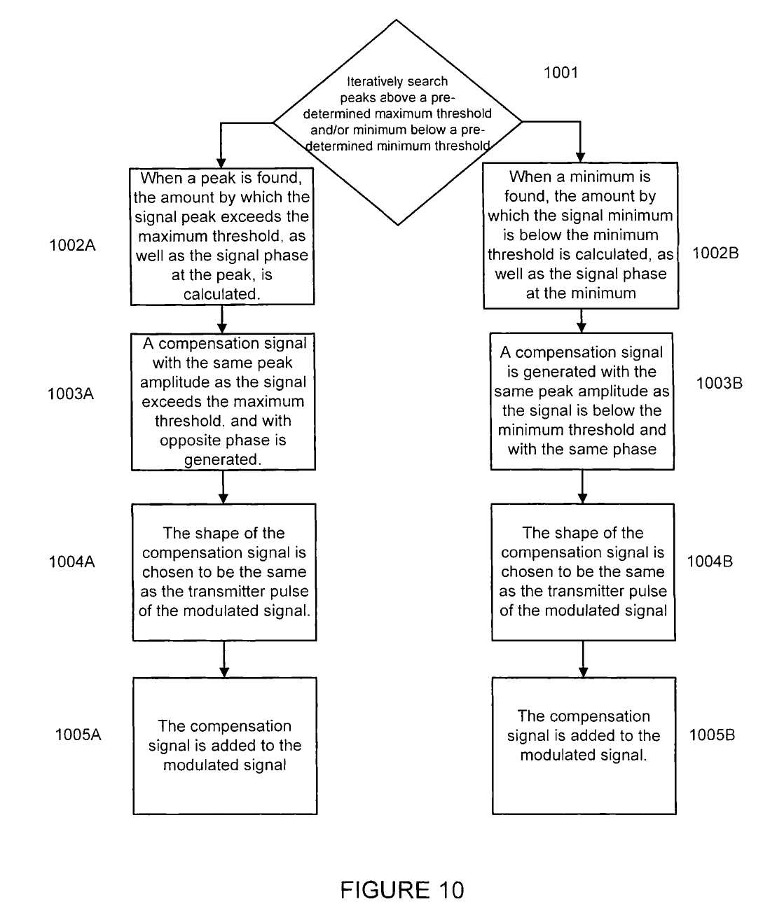

Referring now to FIG. 10, a flow chart of an embodiment of the method of the present invention is presented. As seen therein, in step 1001, peaks above a pre-determined maximum threshold and/or minima below a pre-determined minimum threshold are iteratively searched. In step 1002A, when a peak is found, the amount by which the signal peak exceeds the maximum threshold, as well as the signal phase at the peak, is calculated. In step 1003A, a compensation signal with the same peak amplitude as the signal exceeds the maximum threshold, and with opposite phase is generated. In step 1004A, the shape of the compensation signal is chosen to be the same as the transmitter pulse of the modulated signal. In step 1005A, the compensation signal is added to the modulated signal.

In step 1002B, when a minimum is found, the amount by which the signal minimum is below the minimum threshold is calculated, as well as the signal phase at the minimum. In step 1003B, a compensation signal is generated with the same peak amplitude as the signal is below the minimum threshold and with the same phase. In step 1004B, the shape of the compensation signal is chosen to be the same as the transmitter pulse of the modulated signal; and in step 1005B, the compensation signal is added to the modulated signal.

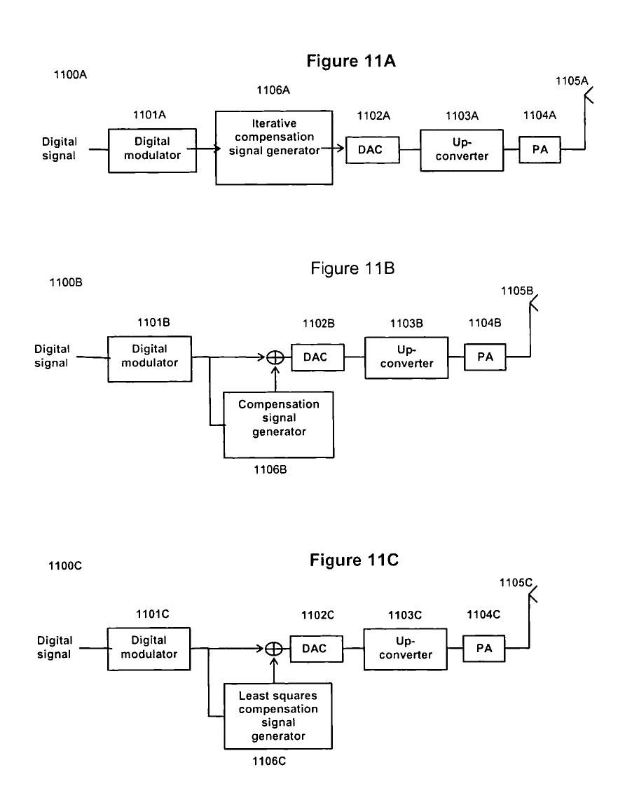

Referring now to FIG. 11A, a block diagram 1100A of the first embodiment of an apparatus of the present invention is presented. As seen therein, the digital information is mapped onto a predefined set of (complex) digital signals using a digital modulator 1101A. The digital modulator also consists of upsampling and passing the signal through a transmit pulse shape filter. The signals are then sent through the iterative compensation signal generator, 1106A, where compensating signals are iteratively added to the modulated signals. The compensating signals are using the same transmit pulse shape filter as the modulated signal. The signals are then converted to analog signals using a digital-to-analog converter (DAC) 1102A, converted to a suitable carrier frequency using an up-converter 1103A, amplified to get a sufficient transmit power using a power amplifier (PA) 1104A and converted to a radio signal by the antenna 1105A.

Referring now to FIG. 11B, a block diagram 1100B of the second embodiment of an apparatus of the present invention is presented. As seen therein, the digital information is mapped onto a predefined set of (complex) digital signals using a digital modulator 1101B. The digital modulator also consists of upsampling and passing the signal through a transmit pulse shape filter. The signals are then sent through the compensation signal generator, 1106B, which adds compensating signals to the modulated signals using the same transmit pulse shape. These are then converted to analog signals using a digital-to-analog converter (DAC) 1102B, converted to a suitable carrier frequency using an up-converter 1103B, amplified to get a sufficient transmit power using a power amplifier (PA) 1104B and converted to a radio signal by the antenna 1105B.

Referring now to FIG. 11C, a block diagram 1100C of the third embodiment of an apparatus of the present invention is presented. As seen therein, the digital information is mapped onto a predefined set of (complex) digital signals using a digital modulator 1101C. The digital modulator also consists of upsampling and passing the signal through a transmit pulse shape filter. The signals are then sent through the compensation signal generator, 1106C, which adds compensating signals, using the same transmit pulse shape filter, to the modulated signals. The compensating signals are generated in a least squares sense. The compensated signals are converted to analog signals using a digital-to-analog converter (DAC) 1102C, converted to a suitable carrier frequency using an up-converter 1103C, amplified to get a sufficient transmit power using a power amplifier (PA) 1104C and converted to a radio signal by the antenna 1105C.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates all modifications that fall within the scope of the invention defined by the following claims.

What is claimed:

1. A method for preserving frequency spectrum in a linear modulation scheme, comprising the step of adding a compensation signal to a modulated signal, the compensation signal having the same spectrum as the modulated signal.

2. The method of claim 1, wherein the amplitude of the modulated signal is compressed.

3. The method of claim 1, further comprising the steps of:
iteratively searching for peaks above a pre-determined maximum threshold and/or minima below a pre-determined minimum threshold;
when a peak is found, calculating the amount by which the signal peak exceeds the maximum threshold, as well as the signal phase at the peak;
generating a compensation signal with the same peak amplitude as the signal exceeds the maximum threshold, and with opposite phase;
choosing the shape of the compensation signal to be the same as the transmitter pulse of the modulated signal; and
adding the compensation signal to the modulated signal.

4. The method of claim 3, further comprising the steps of:
when a minimum is found, calculating the amount by which the signal minimum is below the minimum threshold, as well as the signal phase at the minimum;
generating a compensation signal with the same peak amplitude as the signal is below the minimum threshold and with the same phase;
choosing the shape of the compensation signal to be the same as the transmitter pulse of the modulated signal; and
adding the compensation signal to the modulated signal.

5. The method of claim 4, wherein the procedure is iterated until there are no peaks above the maximum threshold and/or no minima below the minimum threshold.

6. The method of claim 5, wherein the procedure is limited by a maximum number of iterations.

7. The method of claim 1, further comprising the steps of:
calculating a compensation signal by first calculating the (complex) difference between a modulated signal and a signal that would be the result if the amplitude of the modulated signal was hard limited to be below the maximum threshold and/or above the minimum threshold, without changing the phase;
feeding the compensation signal through a filter whose impulse response is the same as the transmitter pulse; and
adding the filtered compensation signal to the modulated signal.

8. The method of claim 1, further comprising using a least squares method to obtain the compensating signal.

9. The method of claim 8 wherein the least squares method cancels out the peaks and minima of the signal that lie outside the linear region of the power amplifier in a least squares sense.

10. The method of claim 1 for use with an 8 PSK modulation scheme.

11. The method of claim 1, for use with a 16 QAM, 32 QAM or 64 QAM modulation scheme.

12. A linear modulation apparatus adapted to preserve frequency spectrum, comprising a means for adding a compensation signal to a modulated signal, the compensation signal having the same spectrum as the modulated signal.

13. The apparatus of claim 12, wherein the amplitude of the modulated signal is compressed.

14. The apparatus of claim 12, further comprising:
means for iteratively searching for peaks above a pre-determined maximum threshold and/or minima below a pre-determined minimum threshold;
means for calculating the amount by which the signal peak exceeds the maximum threshold, as well as the signal phase at the peak when a peak is found;
means for generating a compensation signal with the same peak amplitude as the signal exceeds the maximum threshold, and with opposite phase;
means for choosing the shape of the compensation signal to be the same as the transmitter pulse of the modulated signal; and
means for adding the compensation signal to the modulated signal.

15. The apparatus of claim 14, further comprising:
means for calculating the amount by which the signal minimum is below the minimum threshold, as well as the signal phase at the minimum, when a minimum is found;
means for generating a compensation signal with the same peak amplitude as the signal is below the minimum threshold and with the same phase;
means for choosing the shape of the compensation signal to be the same as the transmitter pulse of the modulated signal; and
means for adding the compensation signal to the modulated signal.

16. The apparatus of claim 15, wherein the procedure is iterated until there are no peaks above the maximum threshold and/or no minima below the minimum threshold.

17. The apparatus of claim 16, wherein the procedure is limited by a maximum number of iterations.

18. The apparatus of claim 12, further comprising:
means for calculating a compensation signal by first calculating the (complex) difference between a modulated signal and a signal that would be the result if the amplitude of the modulated signal was hard limited to be below the maximum threshold and/or above the minimum threshold, without changing the phase;
means for feeding the compensation signal through a filter whose impulse response is the same as the transmitter pulse, and
means for adding the filtered compensation signal to the modulated signal.

19. The apparatus of claim 12, further comprising means for using a least squares method to obtain the compensating signal.

20. The apparatus of claim 19, wherein the least squares method cancels out the peaks and minima of the signal that lie outside the linear region of the power amplifier in a least squares sense.
